(19) United States
(12) Patent Application Publication
(10) Pub. No.: US 2008/0160272 A1
(43) Pub. Date: Jul. 3, 2008

(54) FLEXURALLY RIGID COMPOSITE SHEET

(75) Inventors: Karl-Ludwig Brentrup, Moriken (CH); Andreas Keilbach, Laufenburg/Baden (DE)

Correspondence Address: BROOKS KUSHMAN P.C., 1000 TOWN CENTER, TWENTY-SECOND FLOOR, SOUTHFIELD, MI, 48075, US

(73) Assignee: QUADRANT PLASTIC COMPOSITES AG, Lenzburg (CH)

(21) Appl. No.: 11/955,729

(22) Filed: Dec. 13, 2007

Related U.S. Application Data
(63) Continuation of application No. PCT/CH2006/000310, filed on Jun. 12, 2006.

(30) Foreign Application Priority Data
Jun. 13, 2005 (EP) 05012632.5

(51) Int. Cl. B32B 17/02; B32B 17/00

(52) U.S. Cl. 428/215; 156/99

(57) ABSTRACT

Rigid yet lightweight composite sheets contain a core layer formed by thermal consolidation of a needled non-woven mat of glass fibers and polypropylene fibers, optionally with a melt-bonded polypropylene film on at least one side thereof, sandwiched between layers of GMT. The core contains from 20 to 80 volume percent air voids, whereas the GMT outer layers have a very low or zero void content. The composite sheets may be used for structural panels, for fabricating furniture, and for other uses.

### CROSS-REFERENCE TO RELATED APPLICATIONS

This application is a continuation of PCT Appln. No. PCT/CH2006/000310 filed Jun. 12, 2006, which claims priority to European application 05012632.5 filed Jun. 13, 2005.

### BACKGROUND OF THE INVENTION

1. Field of the Invention

The invention relates to a flexurally rigid composite sheet comprising one or two outer layers of glass-fiber reinforced polypropylene and a core layer of air void-containing glass-fiber reinforced polypropylene.

2. Background Art

Thermoplastically moldable semifinished product sheets of glass-fiber reinforced polypropylene, so called GMT sheets, are increasingly being used for the production of molded parts, in particular for automotive parts. They are produced on an industrial scale by merging of glass mat sheets and polypropylene melt sheets in a double band press and pressing together at pressures far above 1 bar. Such “plastic sheets”, which generally have a thickness of 0.5 to 3 mm, feature a high toughness and consistency.

Published German Patent Application DE-A 195 20 477 discloses fiber reinforced GMT sheets which, when heated, expand due to the restoring forces of the glass mats and which contain air voids with an irregular distribution. Such expanded GMT sheets can be taken as a supporting core and pressed together with non-expanded GMT foils. Example 1 describes an expanded sheet having a glass fiber content of only 30 wt-%. The non-uniform air void size and distribution make these laminates unsuitable for many applications.

### SUMMARY OF THE INVENTION

For many application purposes, in particular for large area parts in the building industry, it is a disadvantage that GMT sheets are rather thin and not flexurally rigid. Therefore, an object of the present invention was to provide flexurally rigid composite sheets that are sufficiently stable and nonetheless lightweight. A further object is to provide a composite panel having air voids which are both uniform in size and distribution. These and other objects are achieved through the preparation of multilayer composites having at least one dense GMT outer layer consolidated with at least one lofty core layer prepared by dry blending glass fibers and thermoplastic fibers to form a non-woven mat, needling the mat to physically consolidate the blended fibers, and consolidating at a temperature sufficient to at least partially melt the thermoplastic fibers, and at a pressure such that an air void content of at least 20 volume percent is maintained.

### DETAILED DESCRIPTION OF THE PREFERRED EMBODIMENT(S)

The subject of the present invention is thus a flexurally rigid composite sheet, comprising:

A. one or two outer layers with a thickness of 0.5 to 5 mm made of glass-fiber reinforced polypropylene with a glass content of 20 to 60 wt-% and an air void content of less than 5 vol-%, and

B. a core layer with a thickness of 2 to 40 mm made of glass-fiber reinforced polypropylene with a glass content of 35 to 80 wt-% and an air void content of 20 to 80 vol-%,

wherein the core layer has been obtained by dry blending of polypropylene fibers and glass fibers, needling of the blended nonwoven, and heat pressing.

For the layer A, one generally employs conventional GMT sheets with a thickness of 0.5 to 5 mm, preferably of 1 to 3 mm, and most preferably about 1.8 mm. These contain 20 to 60, preferably 25 to 50 wt-% of glass fibers. The thermoplastic matrix is polypropylene, which preferably has an MFI (230° C., 2.16 kp) according to DIN 53735 ranging from 20 to 150 g/10 min. The glass fibers are preferably nondirectional and have a weight averaged length of 10 to 100 mm, in particular of 20 to 50 mm. However, it is also possible to use combinations of glass fiber woven fabrics or nonwoven fabrics and layers of nondirectional fibers for the production of the sheets. In any case, the fibers are needled before impregnating with the polypropylene melt, whereupon the fiber mat is consolidated and the fibers are broken to some extent. Because the production process comprises pressing on the double band press and simultaneous cooling, the GMT sheets contain less than 5 vol-% of air voids, preferably less than 2 vol-% and, in particular, no air voids at all.

The core layer B consists of glass-fiber reinforced polypropylene with a glass content of 35 to 80, preferably of 40 to 70 wt-%. The fibers are preferably nondirectional and also needled, but due to the formation of a nonwoven and the needling thereof, some fibers are also aligned in the Z direction. According to the invention it is essential that the core layer contains air voids, namely 20 to 80, preferably 25 to 75 vol-%. The core layer in the finished composite material has a thickness of 2 to 40 mm, preferably 3 to 30 mm. Sheets for the core layer are produced according to the present invention by dry blending of thermoplastic fibers and glass fibers, needling of the blended nonwoven, heating to a temperature above the softening point of the polypropylene and pressing together. Preferably, the consolidation is effected above the melt temperature of the polypropylene such that no or virtually no polypropylene fibers are observable in the consolidated core material. Preferably, the pressing is carried out continuously on a double band press, in particular consecutively by a heated and cooled pressing tool, in each of which the blended nonwoven is pressed at a pressure of less than 0.8 bar at least for 3 sec. Such a process has already been proposed. After blending of the fibers, e.g. according to the carding or airlay process, the glass fiber bundles are opened up, so that the fibers are present as individual filaments. The result is that the air voids remaining in the core layer during the heat pressing of the blended nonwoven are distributed regularly, thus resulting in improved mechanical properties as compared to expanded GMT sheets.

In preferred embodiments, the core layer B is produced by blending reinforcing fibers and thermoplastic fibers as previously discussed, intermingling the fibers by conventional carding or other techniques to achieve a uniform distribution of both types of fibers, and consolidating at elevated temperature under slight pressure to melt or partially melt the thermoplastic fibers, prior to which or concurrently, a film of thermoplastic, preferably polypropylene, is adhered to one side only of the composite material. The polypropylene may be supplied as a solid film or as a melt extruded and still molten film. The consolidation pressure must be such as to maintain the high air void content of minimally 20 volume percent and preferably higher. Thus, the pressure preferably does not exceed about 0.8 bar during consolidation, and is more preferably between 0.1 bar and 0.8 bar.

Advantageously, the composite sheet of the present invention is prepared by a discontinuous process, by stacking the individual layers A and B on top of each other and pressing together in a press at temperatures between 180 and 220° C., preferably between 190 and 210° C. for 5 to 50 min, preferably for 10 to 30 min at pressures between 0.1 and 1 bar, the sequence of the layers preferably being A-B-A.

Due to the fact that with the production process described above the air void-containing sheets can be made only with a thickness of maximally 10 mm, several of such air void-containing sheets are stacked on top of each other during pressing in case that thicker composite sheets need to be produced. When producing the composite sheets, the surface thereof can be refined by simultaneously pressing on functional layers, e.g. foils (which optionally can be colored), textile woven fabrics or thin nonwovens. It is also possible to press mineral granulates into the surface.

In preferred embodiments, panels having two or more core layers B, preferably two to four core layers B, are prepared, for example to form A-B-B-A or A-B-B-B-A panels. The core layers B may be unfaced, but are preferably faced with a polypropylene film on one side of each core layer B. Alternatively, some of the core layers B may be unfaced in such embodiments. It is preferred that polypropylene rich areas, derived either from a polypropylene film melt bonded to the core layer B itself, from a polypropylene film melt bonded to an adjacent core layer B, or from the polypropylene of the GMT layer(s), be present such that a polypropylene rich interfacial zone is formed on preferably each major surface of each core layer B.

Thus, for example, a composite panel may be constructed from a lower GMT layer A; a first core layer B having a thermoplastic film on its upper surface, the lower, unfaced surface contacting the lower GMT layer A; a second core layer B having a thermoplastic film on its upper surface, its lower, unfaced surface contacting the thermoplastic facing of the first core layer B; a third core layer B which may be faced or unfaced, and if faced with a thermoplastic film, this film preferably contacting the lower surface of a topmost GMT layer A, to form an A-B-B-B-A panel of high stiffness, and surprisingly high shear strength as well.

In the case of composite panels having more than one core layer, the consolidation temperature and time must be adjusted so as to fully consolidate the various layers to each other throughout the laminate. The single-faced core layer B thermoplastic film aids in achieving a uniformly laminated product. In the case of laminating multiple core structures, it has been found useful to employ a temperature in the consolidation press of 180° C. to 220° C. for 10 to 15 minutes, followed by cooling in the press for about 10 minutes, for a total cycle time of about 25 minutes. These values are for an A-B-B-A laminate wherein polypropylene fibers are employed in the core layers B. For polypropylene polymers having relatively lower or higher melt temperatures, the temperature range can easily be adjusted by one skilled in the art. Polypropylene with lower melt flow index may also require a slightly higher consolidation temperature or a longer consolidation time, or both.

It is important during consolidation of the multilayer composites, whether containing a single core layer B or multiple core layers B, that the pressure be such that the air void content of the core layers is maintained at minimally about 20 volume percent, preferably 25 to 75 volume percent. If the consolidation pressure is too high, the panel will compress during consolidation and the result will be a much higher density laminate having a low void content, which is undesirable. The consolidation pressure is thus preferably limited to relatively low pressures, with pressures in the range of 0.1 bar to about 1.0 bar, more preferably 0.1 bar to 1.0 bar or less being maintained.

In a particularly preferred embodiment, at least one reinforcing fabric-containing GMT layer A is employed. Such fabric-reinforced GMT is available from Quadrant Plastics Composites AG, Lenzburg, Switzerland, under the tradename GMTex. The particularly preferred laminates contain from 1 to 4 core layers B having an areal weight of preferably 1800 g/m², an air void content of 40-60 volume percent, calculated on a weight basis, and laminate thicknesses between 7 mm and 22 mm.

The fiber-reinforced outer layers can be provided with functional layers, for example with polypropylene foils for sealing, optical improvement, adhesion promotion and the like.

Woven fabrics, nonwoven fabrics and others forms of directional reinforcements can be embedded in the external layers in order to provide the entire sandwich composite with an extreme stiffness.

In comparison with the conventional GMT sheets A, the composite sheets of the present invention have the advantage of being flexurally rigid and suitable for insertion of nails and screws. In comparison to the air voids containing sheets B without outer layers they have the advantage of having a smooth, abrasion resistant and waterproof surface and also a better stiffness.

In comparison with the known composite sheets with a core layer having foam or honeycomb structures and GMT outer layers, the composite sheets of the present invention have the advantage of better compressive and shear strength.

The major application fields of the composite sheets are partition walls and boarding elements for construction and also for manufacturing of furniture as an alternative to chipboard and plywood.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A flexurally rigid composite sheet, comprising a thermally consolidated sandwich structure comprising:
A. one or two outer layers with a thickness of 0.5 to 5 mm comprising glass-fiber reinforced polypropylene with a glass content of 20 to 60 wt-% and an air void content of less than 5 vol-%, and
B. a core layer with a thickness of 2 to 40 mm comprising glass-fiber reinforced polypropylene with a glass content of 35 to 80 wt-% and an air void content of 20 to 80 vol-%,
wherein the core layer has been obtained by dry blending of polypropylene fibers and glass fibers, needling of the blended nonwoven, and heat pressing.

2. The composite sheet of claim 1, wherein the glass fibers in layer A are present as a needled mat of nondirectional fibers with an average length (weight average) of 10 to 100 mm or as a woven fabric or nonwoven fabric needled with directional or nondirectional fibers.

3. The composite sheet of claim 1, wherein the glass fibers in layer B are nondirectional fibers with an average length (weight average) of 10 to 60 mm needled together.

4. The composite sheet of claim 1, having the layer sequence A-B-A.

5. The composite sheet of claim 1, which is provided on one or both sides thereof with a functional layer.

6. The composite sheet of claim 5, wherein at least one functional layer selected from the group consisting of foils, woven textile fabrics and fiber nonwovens.

7. The composite sheet of claim 1, comprising two outer layers A and a plurality of core layers B, at least one core layer B faced with a polypropylene film layer on at least one side thereof prior to consolidation of the sandwich structure.

8. A method for producing a composite sheet of claim 1, comprising:
providing a core layer B prepared by consolidating a needled blend of glass fibers and polypropylene fibers at a temperature higher than the melt temperature of the polypropylene and at a pressure such that the consolidated core layer B has an air void content of 20 to 80 volume percent;
providing two GMT layers A, with at least one core layer B between said two GMT layers A to form a consolidatable sandwich structure;
consolidating said sandwich structure at a temperature greater than the melt temperature of the polypropylene and at a pressure not exceeding about 1.0 bar for a time sufficient to thermally consolidate the sandwich structure, and
cooling the consolidated sandwich structure under pressure to form said rigid composite sheet.

9. The method of claim 8, wherein at least one GMT layer A contains at least one fabric reinforcing layer of unidirectional or bidirectional fibers.

10. The method of claim 8, wherein two or more core layers B are present.

11. The method of claim 8, wherein two or more core layers B are present, at least one core layer B having a polypropylene film melt bonded to at least one surface thereof.

12. The method of claim 8, wherein two or more core layers B are present, and each major surface of each core layer B is melt bonded to a polypropylene film, is adjacent to a melt bonded polypropylene film of an abutting core layer B, or is adjacent to a GMT layer A, prior to consolidation, such that a polypropylene-rich interface will be formed at the major surfaces of core layers B upon consolidation.

13. A method for producing a composite sheet of claim 8, wherein the layers A and B are pressed together discontinuously in a press at temperatures between 180 and 220° C. for 5 to 50 min.

14. The method claim 8, wherein the core layer B is composed of several single layers stacked on top of each other, each layer having a thickness of 1 to 10 mm.

15. The method of claim 10 wherein said consolidated sandwich structure is consolidated in a press at a temperature of from 180° C. to 220° C. at a pressure of about 1.0 bar or less.

16. The method of claim 15, wherein said consolidated sandwich structure is an A-B-B-A composite sheet.

17. The method of claim 8, wherein the consolidated core layer B no longer contains polypropylene fibers.
